(19) United States
(12) Patent Application Publication
(10) Pub. No.: US 2007/0064521 A1
(43) Pub. Date: Mar. 22, 2007

(54) Apparatus for vibrating sample containers

(75) Inventor: Sergio Szabo Miszenti, Milan (IT)

Correspondence Address: Miller, Matthias & Hull;One North Franklin, Suite 2350, Chicago, IL, 60606, US

(73) Assignee: FLUID MANAGEMENT OPERATIONS LLC, Wheeling, IL (US)

(21) Appl. No.: 11/233,080

(22) Filed: Sep. 22, 2005

(51) Int. Cl. B01F 11/00

(52) U.S. Cl. 366/208

(57) ABSTRACT

An apparatus for shaking containers holding samples is disclosed having a motor with a rotatable shaft defining a shaft axis. A rotor is coupled to and rotatable with the shaft, and at least three cam assemblies are coupled to and rotatable with the rotor. Each cam assembly includes a cam defining a support surface, and the at least three cam assemblies are oriented so that the support surfaces define a rotating plane disposed at an oblique angle with respect to the shaft axis during rotation of the cam assemblies. A socket is supported in a fixed position with respect to the rotor, and a ball is retained by and pivotable within the socket. A loading plate adapted to hold the samples is coupled to the ball to allow pivotable movement of the loading plate with respect to the rotor, the loading plate having a drive surface engaging the cam support surfaces. An anti-rotation mechanism engages the loading plate. Operation of the apparatus generates a non-rotational, oscillating motion of the loading plate which reciprocates the samples along an arcuate path.

### FIELD OF THE DISCLOSURE

The present disclosure generally relates to apparatus for rapidly vibrating sample containers or vessels and, more particularly, for mechanically lysing biological samples.

### BACKGROUND OF THE DISCLOSURE

Apparatus for shaking, vibrating, or oscillating laboratory samples are generally known in the art. These devices and methods are often used to process biological samples. For example, sample cells may be deposited into a container such as a vial along with a buffer fluid and impact media, which may be provided as microbeads formed of glass, ceramic or other material. The shaking apparatus rapidly oscillates the vials so that that impact media impacts the sample material. In the case of biological samples, the oscillating movement of the vial is sufficiently rapid so that the impact media fractures the cell walls of the sample material to release genetic material, such as RNA or DNA.

Various types of methods and apparatus have been proposed for mechanically shaking samples. Some of these devices, such as the shaker disclosed in U.S. Pat. No. 6,579,002, which issued on Jun. 17, 2003 to Bartick et al., employ reciprocating pistons to provide the shaking force applied to the samples. This piston-operated device, however, is overly limited by the number of samples it may simultaneously process.

Other devices, such as those disclosed in U.S. Pat. No. 5,567,050, which issued on Oct. 22, 1996 to Zlobinsky et al., and U.S. Publication No. US 2005/0128863 A1, which published on Jun. 16, 2005 listing Esteve et al. as inventors, use an oscillating disk or plate that is capable of processing several sample as once. Typically, the plate in such devices is not rotated but instead is manipulated in a tilting, oscillatory motion. For example, the '050 patent noted above discloses a tube support disk and a means for imparting oscillating motion to the disk about a center of the disk. The drive means comprise an electric motor with an outlet shaft and a sleeve placed over the outlet shaft having an outside cylindrical surface that slopes obliquely relative to the axis of the outlet shaft. The sleeve is mounted free to rotate in the disk by means of rolling bearings in axial alignment, and the disk is associated with means for preventing it from rotating, so that when the sleeve is rotated by the motor, it causes the disk to oscillate about a center of rotation which is formed by the intersection between the axis of the motor shaft and the axis of the cylindrical outside surface of the sleeve. Tubes fixed at the periphery of the disk at equal distances from the center of rotation are thus subjected to substantially curvilinear reciprocating motion. U.S. Publication No. US 2005/0128863 A1 similarly discloses a vibration device having bearings that are oriented along an axis that is substantially perpendicular to the support disk, and therefore similarly generates bending forces on the bearings.

The currently known oscillating plate devices may place undue strain on the bearings, thereby making the bearings a wear component that may limit the useful life of the device. It is therefore desirable to provide an oscillating plate device that reduces or minimizes bending forces thereby to increase the life of the device.

### SUMMARY OF THE DISCLOSURE

In accordance with certain aspects of the disclosure, an apparatus for shaking containers holding samples is provided which includes a motor having a rotatable shaft defining a shaft axis. A rotor is coupled to and rotatable with the shaft, and at least three cam assemblies are coupled to and rotatable with the rotor. Each cam assembly includes a cam defining a support surface, and the at least three cam assemblies are oriented so that the support surfaces define a rotating plane disposed at an oblique angle with respect to the shaft axis during rotation of the cam assemblies. A socket is supported in a fixed position with respect to the rotor, and a ball is retained by and pivotable within the socket. A loading plate adapted to hold the samples is coupled to the ball to allow pivotable movement of the loading plate with respect to the rotor, the loading plate having a drive surface engaging the cam support surfaces. An anti-rotation mechanism engages the loading plate. Operation of the apparatus generates a non-rotational, oscillating motion of the loading plate which reciprocates the samples along an arcuate path.

According to additional aspects of the disclosure, apparatus for shaking containers holding samples is provided that includes a motor having a rotatable shaft defining a shaft axis, a rotor coupled to and rotatable with the shaft, and at least three cam assemblies coupled to and rotatable with the rotor. Each cam assembly includes a cam defining a support surface, and the at least three cam assemblies are oriented so that the three support surfaces define a rotating plane disposed at an oblique angle with respect to the shaft axis during rotation of the cam assemblies. A loading plate adapted to hold the samples is supported for pivotable movement with respect to the rotor. The loading plate has a drive surface engaging the cam support surfaces, and an anti-rotation mechanism engages the loading plate.

In accordance with further aspects of the disclosure, apparatus for shaking containers holding samples is disclosed which includes a motor having a rotatable shaft defining a shaft axis, a rotor coupled to and rotatable with the shaft, and a cam assembly coupled to and rotatable with the rotor, the cam assembly defining at least one support surface aligned along a rotating plane disposed at an oblique angle with respect to the shaft axis during rotation of the cam assembly. A socket is supported in a fixed position with respect to the rotor, a ball is retained by and pivotable within the socket, and a loading plate adapted to hold the samples is coupled to the ball to allow pivotable movement of the loading plate with respect to the rotor. The loading plate has a drive surface engaging the at least one support surface, and an anti-rotation mechanism engages the loading plate.

Other advantages and features of the disclosed embodiments and methods will be best understood upon reference to the accompanying drawings and detailed description that follows.

### BRIEF DESCRIPTION OF THE DRAWINGS

FIG. 1 is a perspective view of a sample shaking apparatus in accordance with the present disclosure;

FIG. 2 is a perspective view, in partial cross-section, of the sample shaking apparatus as shown in FIG. 1;

FIG. 3 is an enlarged side-view, in cross-section, of a portion sample shaking apparatus of FIG. 1;

FIG. 4 is a perspective view of a sample shaking apparatus in accordance with another embodiment of the present disclosure;

FIG. 5 is a perspective view, in partial cross-section, of the sample shaking apparatus as shown in FIG. 4;

FIG. 6 is an enlarged side view, in cross-section, of a portion of the sample shaking apparatus as shown in FIG. 4;

FIG. 7 is a perspective view of a sample shaking apparatus in accordance with a further embodiment of the present disclosure;

FIG. 8 is an enlarged side view, in cross-section, of a portion of the sample shaking apparatus shown in FIG. 7;

FIG. 9 is an enlarged side view, in cross-section, illustrating a further embodiment of a sample shaking apparatus in accordance with the present disclosure; and

FIG. 10 is an enlarged plan view of an anti-rotation spring used in certain embodiments of the sample shaking apparatus.

It should be understood that the drawings are not necessarily to scale and that the disclosed embodiments are illustrated using diagrammatic representations and fragmentary views. In certain instances, details may have been omitted which are not necessary for an understanding of the disclosed embodiments or which render other details difficult to perceive. It should be understood, of course, that the sample shaking apparatus is not necessarily limited to the particular embodiments disclosed herein.

### DETAILED DESCRIPTION

Various embodiments of sample shaking apparatus suitable for agitating or otherwise processing material samples are disclosed herein. Specifically, apparatus is described for lysing and purifying nucleic acids from a biological sample using mechanical means. To prepare the sample for use in such devices, the material is typically deposited into a container such as a vial along with a buffer liquid and impact media such as microbeads. One or more sample containers are then placed in the shaking apparatus which accelerates the source material to high acceleration or “g” levels in a reversible fashion such that bead impacts with the source material cause cell disruption or fracture, thereby allowing release of nucleic acids from the cells. While the apparatus disclosed herein are described in the context of lysing biological samples, it will be appreciated that the shaking apparatus may be suitable for other materials or processes that may benefit from the advantages taught herein.

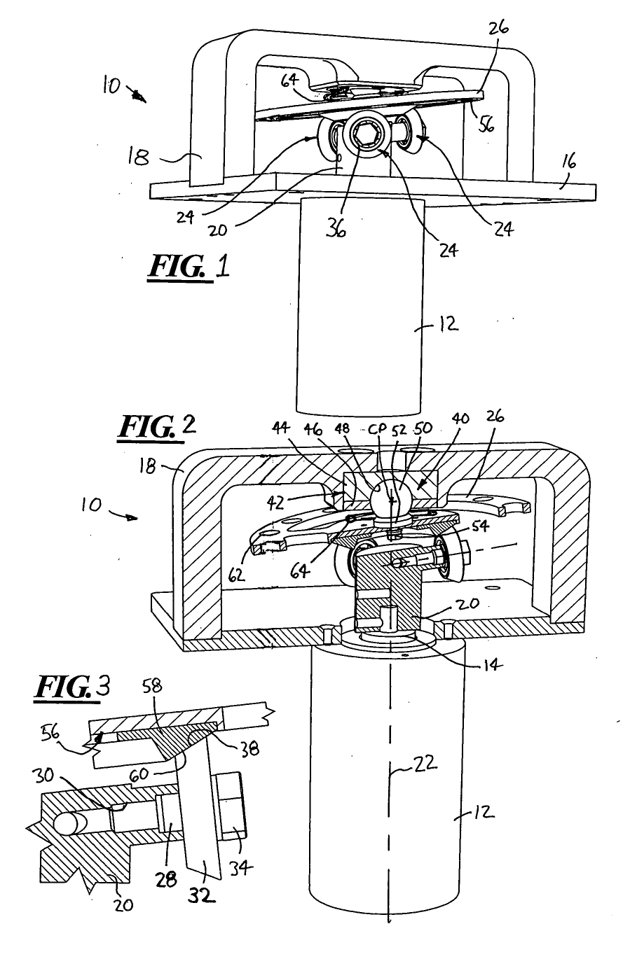

With reference to FIGS. 1-3, an exemplary embodiment of a shaking apparatus 10 includes a motor 12 having a rotatable shaft 14. A base plate 16 is coupled to the motor 12 and supports a frame 18. A rotor 20 is coupled to and rotatable with the motor shaft 14. The shaft 14 defines an axis 22 about which the shaft and attached rotor 20 rotate.

At least one cam assembly 24 is coupled to the rotor 20 for supporting a loading plate 26 at an oblique angle with respect to the shaft axis 22, as described in greater detail below. In the illustrated embodiment, three cam assemblies 24 are coupled to the rotor 20. Each cam assembly 24 includes an axle 28 sized for insertion into a bore 30 formed in the rotor 20 (FIG. 3). A cam, such as rotatable driving wheel 32, is journally supported on an associated axle 28 and a fastener 34 retains the driving wheel on the axle. A rotary bearing 36 (FIG. 1) may be disposed between the axle 28 and the driving wheel 32 to facilitate rotation of the wheel. Each of the driving wheels 32 defines a support surface 38 which engages the loading plate 26. The axles 28 are oriented along a plane that forms an oblique angle with respect to the motor shaft axis 22. Accordingly, the surfaces 38 support the loading plate 26 at an oblique angle with respect to the axis 22. As used herein, the term “oblique angle” means any angle other than a right angle.

The loading plate 26 is supported from the frame 18 in a manner which allows it to freely pivot about a center point. In the illustrated embodiment, the loading plate 26 is coupled to the frame 18 by a ball joint 40. The ball joint 40 includes a socket 42 coupled to the frame 18 and formed by a socket block 44 and retainer plate 46. The socket 42 defines a partially spherical receptacle 48 sized to receive ball member 50. A backing plate 52 is coupled to the ball member 50 and a fastener 54 is inserted through an aperture formed in the loading plate 26 and threadably received by a threaded aperture formed in the ball member 50, thereby to couple the loading plate to the ball member 50. The pivotable engagement between the ball member 50 and the socket 42 enables the loading plate 26 to freely pivot about a center point CP of the ball member 50. The ball-joint may be formed of a self-lubricating plastic material (such as PEEK), or other similar material.

The loading plate 26 includes a drive surface 56 adapted to engage the driving wheels 32. In the illustrated embodiment, the driving wheels 32 each have a beveled outer surface for engaging the loading plate 26 and the loading plate 26 includes a wear ring 58. As best shown with reference to FIG. 3, the wear ring 58 includes a tapered surface 60 that is complimentary to the tapered support surface 38 of each driving wheel 32. The wheels 32 and wear ring 58 may be formed of steel (such as heat-treated carbon C40 steel), a self-lubricating plastic material (such as PEEK), or other similar material.

The loading plate 26 further includes a plurality of apertures 62 located at a periphery thereof for receiving sample material. In the illustrated embodiment, the apertures 62 are round and sized to receive cylindrical vials (not shown) which hold the sample material and any impact media. The apertures 62 may be sized to produce an interference or near-interference fit with the vials, thereby to hold the vials on the loading plate during operation. Alternatively, well-known locking mechanisms may be employed to retain the vials on the loading plate.

An anti-rotation mechanism, such as spring 64, is provided for preventing the loading plate from rotating during operation. As best shown in FIGS. 1 and 2, the spring 64 is coupled at one end to the loading plate 26 and at an opposite end to the frame 18. The spring 64 may be formed in a semi-circular or arcuate shape, and the ends may be coiled to receive fasteners 65, 66 for securing the ends of the spring 64 to the frame 18 and loading plate 26, respectively (FIG. 10). The spring 64 is relatively stiff to substantially prevent rotation of the loading plate 26 during operation. The shape and design of the illustrated spring 64 are particularly suited for impeding rotating oscillations of the loading plate 26 in both directions, thereby minimizing wear and noise generation.

In operation, when the motor 12 of the shaking apparatus 10 is energized, the rotor 20 and attached cam assemblies will rotate with the motor shaft 14. The driving wheels 32, which engage the wear ring 58 of the loading plate 26, orient the loading plate 26 at an oblique angle with respect to the motor shaft axis 22. As a result, a first portion of the loading plate 26 is located above than a horizontal reference line while an opposing portion of the loading plate 26 is located below the horizontal reference line. As the driving wheels 32 rotate, the locations of the higher and lower portions of the loading plate 26 will change. Accordingly, when the driving wheels 32 rotate 180°, the portion that was below the horizontal reference point will be above the horizontal reference point, and vice versa. By rapidly rotating the driving wheels 32, the loading plate 26 will move in a tilting, oscillatory motion that reciprocates the sample containers in a reversing arcuate path, thereby processing the sample material inside the vials as desired. The spring 64 prevents the loading plate 26 from rotating, thereby causing the loading plate 26 to move in a non-rotational oscillating manner.

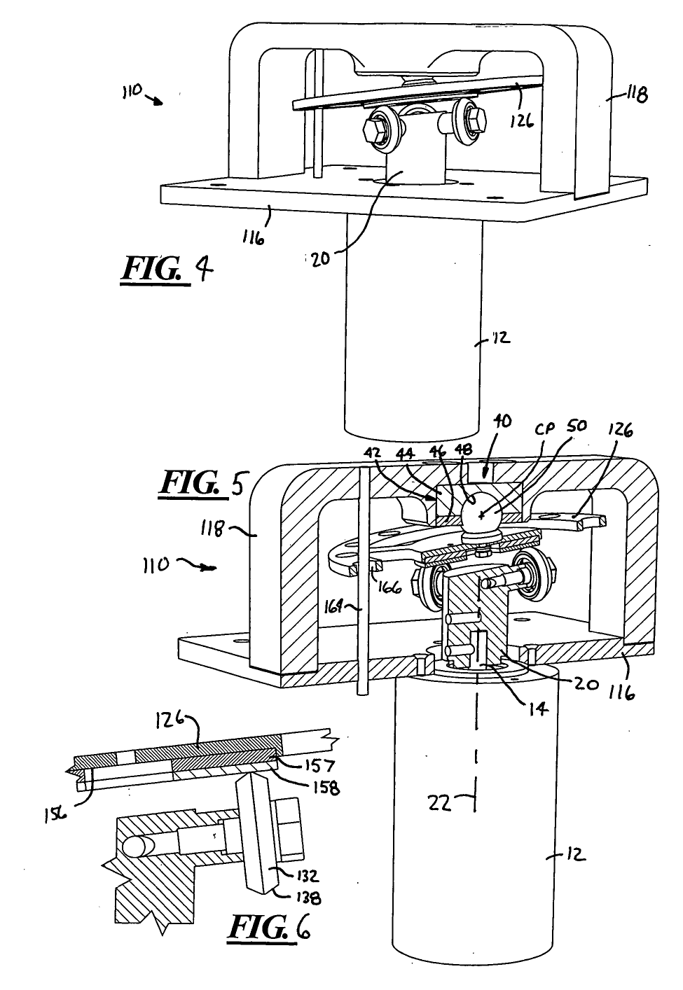

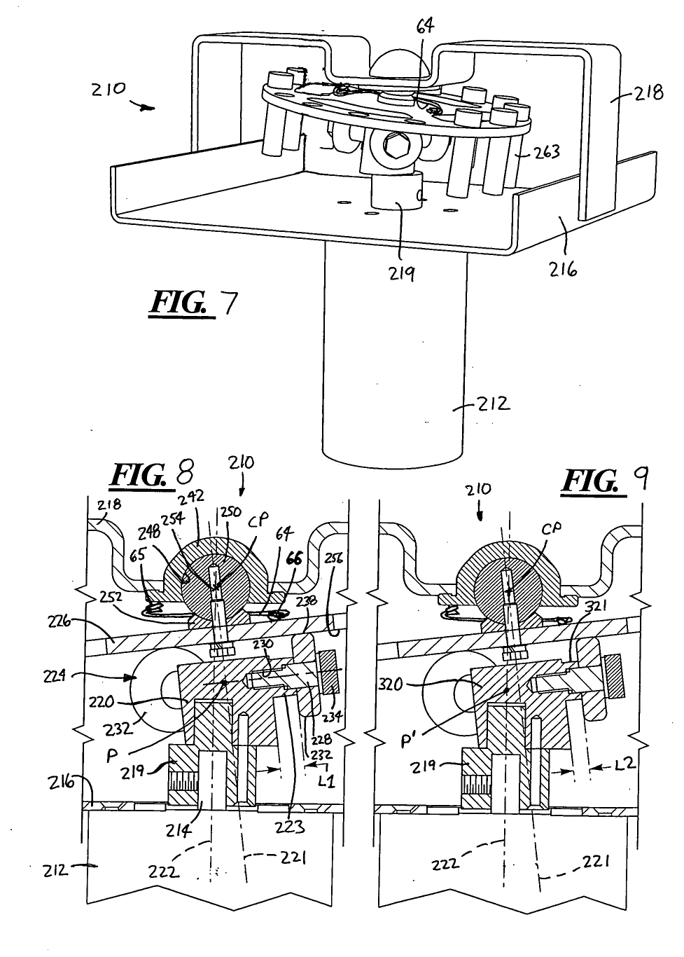

Another shaking apparatus embodiment is illustrated in FIGS. 4-6. This embodiment is substantially similar to that shown in FIGS. 1-3 and therefore like reference numerals have been used to identify similar components. The primary difference in this embodiment is the construction of the rotatable driving wheel and loading plate drive surface, as explained more fully below.

More specifically, and as best shown in FIGS. 4 and 5, the shaking apparatus 110 includes a rotatable driving wheel 132 with a double-beveled outer surface 138. The double-beveled outer surface 138 forms an apex near a center of the wheel 132 to more precisely define the area of contact with the loading plate 126. The loading plate 126 includes a backing plate 157 and a wear ring 158 coupled to a drive surface 156 of the loading plate 126. This embodiment also provides an alternative anti-rotation mechanism in the form of a pin 164 extending between the base plate 116 and frame 118. The loading plate 126 includes a through hole 166 sized to receive the pin 164. The through-hole 166 is sized to create substantial radial clearance between the pin 164 and the through-hole 166 thereby to accommodate the arcuate movement of the loading plate 126 about the center CP of the ball member 50 during operation of the shaking apparatus. The shaking apparatus 110 operates in substantially the same manner as the shaking apparatus 10 described above.

Yet another embodiment of a shaking apparatus 210 is illustrated in FIGS. 7-9 that is similar to the previous embodiments described above. More specifically, the shaking apparatus 210 includes a motor 212 having a rotatable shaft 214. A base plate 216 is attached to the motor 212 and has a frame 218 coupled thereto. An adapter 219 is coupled to the motor shaft 214 and a rotor 220 is coupled to the adapter 219. The rotor 220 carries three cam assemblies 224 which are oriented at an oblique angle with respect to a motor shaft axis 222. Each cam assembly 224 includes an axle 228 inserted into a bore 230 formed in the rotor 220. A rotatable driving wheel 232 is journally supported on each axle 228 and is retained on the axle by a fastener 234. In this embodiment, each rotatable driving wheel 232 defines a generally cylindrical support surface 238 which may directly engage a drive surface 256 of a loading plate 226. The orientation of the cam assemblies 224 cause the loading plate 226 to form an oblique angle with respect to the motor shaft axis 222 that is aligned with a tilt axis 221. The frame 218 carries a socket 242 defining a semi-spherical receptacle 248. A ball member 250 is sized for pivotable insertion into the receptacle 248 and has a backing plate 252 attached thereto. A fastener 254 is inserted through an aperture in the loading plate 226 and threadably engages a threaded aperture formed in the ball member 250.

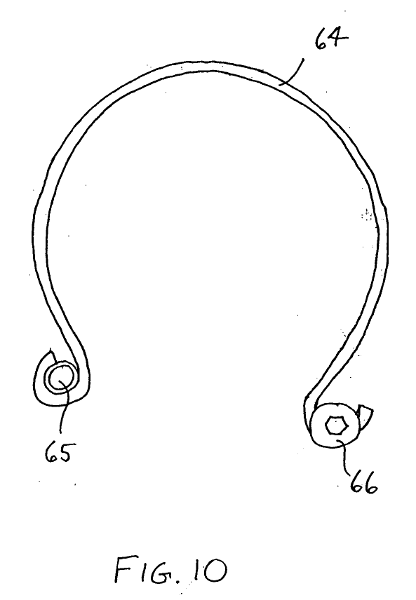

FIGS. 8 and 9 illustrate alternative component alignments for the shaking apparatus 210. In FIG. 8, the rotor 220 is offset with respect to the ball center point CP. More specifically, while the ball center point CP is aligned with the motor shaft axis 222, a point P at which the axes 228 of the three driving wheels intersect does not fall along the motor shaft axis 222. Accordingly, the rotor 220 shown in FIG. 8 is said to be “offset” from the ball center point CP. In FIG. 9, however, a rotor 320 is formed so that the point P′ at which the driving wheel axes 228 intersect falls along the motor shaft axis 222, and therefore is aligned with the ball center point CP. The exact rotor alignment is difficult to identify in FIGS. 8 and 9, but is more readily discernable with reference to arm 223 shown in FIG. 8 having a length L1, and arm 321 shown in FIG. 9 having a length L2 shorter than L1. Accordingly, the rotor 220 of FIG. 8 is offset to the right as compared to the rotor 320 of FIG. 9. For the embodiment illustrated in FIGS. 1-3 having beveled or conic shaped wheels, it has been found that the offset rotor alignment illustrated in FIG. 8 is preferred.

It will be appreciated that the angle between the tilt axis and the motor shaft axis is directly proportional to the stroke distance along which the sample traverses during operation. Consequently, the apparatus may be adapted to couple with several different rotor assemblies, each of which producing a different tilt axis, thereby to provide a single apparatus capable of generate varied stroke lengths.

This embodiment also employs the anti-rotation spring 64 noted above with respect to the embodiment of FIGS. 1-3. Accordingly, the spring 64 is coupled at one end to the loading plate 226 and at an opposite end to the frame 218. As best shown in FIG. 10, the spring 64 may be formed in a semi-circular or arcuate shape, and the ends may be coiled to receive fasteners 65, 66 for securing the ends of the spring 64 to the frame 218 and loading plate 226, respectively. Again, the spring 64 is relatively stiff to substantially prevent rotation of the loading plate 226 during operation

While only certain embodiments have been set forth, alternative embodiments and various modifications will be apparent from the above description to those skilled in the art. These and other alternatives are considered equivalents and within the spirit and scope of this disclosure.

What is claimed is:

1. Apparatus for shaking containers holding samples, the apparatus comprising:
a motor having a rotatable shaft defining a shaft axis;
a rotor coupled to and rotatable with the shaft;
at least three cam assemblies coupled to and rotatable with the rotor, each cam assembly including a cam defining a support surface, the at least three cam assemblies being oriented so that the support surfaces define a rotating plane disposed at an oblique angle with respect to the shaft axis during rotation of the cam assemblies;
a socket supported in a fixed position with respect to the rotor;
a ball retained by and pivotable within the socket;
a loading plate adapted to hold the samples coupled to the ball to allow pivotable movement of the loading plate with respect to the rotor, the loading plate having a drive surface engaging the cam support surfaces; and
an anti-rotation mechanism engaging the loading plate.

2. The apparatus of claim 1, in which each cam comprises a rotatable driving wheel journally supported on an associated arm.

3. The apparatus of claim 1, in which the loading plate drive surface includes a tapered surface and in which each cam defines an outer surface having a complementary taper.

4. The apparatus of claim 1, in which the containers comprise vials and in which the loading plate includes a plurality of apertures, each aperture being sized to receive an outer surface of an associated vial.

5. The apparatus of claim 1, in which the samples comprise biological samples.

6. Apparatus for shaking containers holding samples, the apparatus comprising:
a motor having a rotatable shaft defining a shaft axis;
a rotor coupled to and rotatable with the shaft;
at least three cam assemblies coupled to and rotatable with the rotor, each cam assembly including a cam defining a support surface, the at least three cam assemblies being oriented so that the three support surfaces define a rotating plane disposed at an oblique angle with respect to the shaft axis during rotation of the cam assemblies;
a loading plate adapted to hold the samples and supported for pivotable movement with respect to the rotor, the loading plate having a drive surface engaging the cam support surfaces; and
an anti-rotation mechanism engaging the loading plate.

7. The apparatus of claim 6, in which each cam comprises a rotatable driving wheel journally supported on an associated arm.

8. The apparatus of claim 6, further comprising a socket supported in a fixed position with respect to the rotor and a ball retained by and pivotable within the socket, wherein the ball is coupled to the loading plate.

9. The apparatus of claim 6, in which the loading plate drive surface includes a tapered surface and in which each cam defines an outer surface having a complementary taper.

10. The apparatus of claim 6, in which the containers comprise vials and in which the loading plate includes a plurality of apertures, each aperture being sized to receive an outer surface of an associated vial.

11. The apparatus of claim 6, in which the samples comprise biological samples.

12. Apparatus for shaking containers holding samples, the apparatus comprising:
a motor having a rotatable shaft defining a shaft axis;
a rotor coupled to and rotatable with the shaft;
a cam assembly coupled to and rotatable with the rotor, the cam assembly defining at least one support surface aligned along a rotating plane disposed at an oblique angle with respect to the shaft axis during rotation of the cam assembly;
a socket supported in a fixed position with respect to the rotor;
a ball retained by and pivotable within the socket;
a loading plate adapted to hold the samples coupled to the ball to allow pivotable movement of the loading plate with respect to the rotor, the loading plate having a drive surface engaging the at least one support surface; and
an anti-rotation mechanism engaging the loading plate.

13. The apparatus of claim 12, in which the cam assembly comprises at least three cams, each cam defining a support surface, wherein the at least three cam assemblies are oriented so that the three support surfaces define a rotating plane disposed at an oblique angle with respect to the shaft axis during rotation of the cam assemblies.

14. The apparatus of claim 13, in which each cam comprises a rotatable driving wheel journally supported on an associated arm.

15. The apparatus of claim 12, in which the loading plate drive surface includes a tapered surface and in which each cam defines an outer surface having a complementary taper.

16. The apparatus of claim 12, in which the containers comprise vials and in which the loading plate includes a plurality of apertures, each aperture being sized to receive an outer surface of an associated vial.

17. The apparatus of claim 12, in which the samples comprise biological samples.
